(19) United States
(12) Patent Application Publication
(10) Pub. No.: US 2025/0110504 A1
(43) Pub. Date: Apr. 3, 2025

(54) SYSTEMS AND METHODS FOR MOBILE DEVICE CONTROL USING LANGUAGE INPUT

(71) Applicant: Apple Inc., Cupertino, CA (US)

(72) Inventors: Wei Cheng KUO, San Jose, CA (US); Hugues THOMAS, Sunnyvale, CA (US); Jian ZHANG, Saratoga, CA (US)

(21) Appl. No.: 18/889,305

(22) Filed: Sep. 18, 2024

Related U.S. Application Data
(60) Provisional application No. 63/586,312, filed on Sep. 28, 2023.

(51) Int. Cl. G05D 1/246; G05D 1/223; G05D 1/229; G06T 7/70

(52) U.S. Cl. CPC G05D 1/2467; G05D 1/223; G05D 1/229; G06T 7/70; G06T 2207/20072

(57) ABSTRACT

Aspects of the present disclosure relate to systems and methods for mobile device control using language input.

### CROSS-REFERENCE TO RELATED APPLICATIONS

This application claims the benefit of U.S. Provisional Application No. 63/586,312, filed Sep. 28, 2023, the content of which is herein incorporated by reference in its entirety for all purposes.

### FIELD OF THE DISCLOSURE

Aspects of the present disclosure relate to systems and methods for mobile device control using language input.

### BACKGROUND OF THE DISCLOSURE

Navigation systems obtain user input that specifies a destination. Users, however, may follow a rigid paradigm for providing such input. Alternatively, navigation occurs without a rigid paradigm for providing inputs, but the results may be contrary to user intention.

### SUMMARY OF THE DISCLOSURE

Systems and methods for language-based navigation in an environment using language inputs are described below. A multi-modal model, trained using image-language pairs, is used to generate a map of an environment based on image inputs and is used to generate search queries for the map of the environment based on language inputs. The multi-modal model converts the language inputs or image inputs into embeddings in a shared embedding space.

In some embodiments, a mobile device receives an input including a language-based navigation command, such as a description associated with an object in a mapped environment. The mobile device is configured to generate an embedding corresponding to the input as a query of a map of the environment (e.g., a multi-modal node graph). The mobile device determines a target pose of the mobile device in the mapped environment corresponding to the embedding. For example, the mobile device determines the target pose based identifying a threshold similarity of the query embedding to one of a plurality of embeddings of a multi-modal node graph. The mobile device moves to a location and an orientation of the target pose in the mapped environment. In some embodiments, the environment map (e.g., multi-modal node graph) includes representations of a plurality of poses of the mobile device in the mapped environment and the plurality of embeddings correspond to the plurality of poses of the mobile device in the mapped environment.

### BRIEF DESCRIPTION OF THE DRAWINGS

FIG. 1 is a block diagram of an example mobile device according to one or more embodiments of the disclosure.

FIG. 2 is a block diagram of a system for language-based navigation using a pose-embedding graph according to one or more embodiments of the disclosure.

FIG. 3 illustrates an example pose-embedding node graph according to one or more embodiments of the disclosure.

FIG. 4 illustrates an example multi-modal model according to one or more embodiments of the disclosure.

FIG. 5 is a flow diagram of a method for mapping an environment according to one or more embodiments of the disclosure.

FIG. 6 illustrates a updating an example pose-embedding node graph according to one or more embodiments of the disclosure.

FIG. 7 is a flow diagram of an example method for language-based navigation according to one or more embodiments of the disclosure.

### DETAILED DESCRIPTION

Systems and methods for language-based navigation in an environment using language inputs are described below. A multi-modal model, trained using image-language pairs, is used to generate a map of an environment based on image inputs and is used to generate search queries for the map of the environment based on language inputs. The multi-modal model converts the language inputs or image inputs into embeddings in a shared embedding space. The environment map generated using the multi-modal model is optionally a pose-embedding node graph, which includes pose and embedding information. An embedding based on a language input is used to query the environment map and return a target pose.

The systems and methods described herein improve language-based navigation. For example, the multi-modal model enables an open vocabulary for navigation inputs (e.g., not requiring specific vocabulary for instructions to enable successful navigation). Additionally or alternatively, localizing the pose-embeddings in the environment map is computationally efficient and avoids the need for generating semantic understanding of the environment in the environment map. Additionally, determining a navigation goal based on the input described herein is computationally efficient. For example, because the target pose is returned as an output of the embedding-based query, the mobile device does need to determine a preferential location and orientation in addition to determining the navigation goal of the input. Additionally, using embeddings for loop closure improves the stability of simultaneous localization and mapping techniques.

In some embodiments, a mobile device receives an input including a language-based navigation command, such as a description associated with an object in a mapped environment. The mobile device is configured to generate an embedding corresponding to the input for a query of a map of the environment (e.g., a multi-modal node graph). The mobile device determines a target pose of the mobile device in the mapped environment corresponding to the embedding. For example, the mobile device determines the target pose, based on identifying a threshold similarity of the query embedding to one of a plurality of embeddings of a multi-modal node graph. The mobile device moves to a location and an orientation of the target pose in the mapped environment. In some embodiments, the environment map (e.g., multi-modal node graph) includes representations of a plurality of poses of the mobile device in the mapped environment and the plurality of embeddings correspond to the plurality of poses of the mobile device in the mapped environment.

Language-based navigation referred to herein includes instructions, such as natural language text or verbal commands, to a mobile device to navigate to an object (without predefined targets corresponding to the object). For example, an instruction for the mobile device includes an instruction to “go to an object,” where the object of the instruction is replaced with a direct reference to an object such as a door, a lamp, a refrigerator, a painting, or a sofa. However, natural language commands may include alternate expressions or more descriptive expressions. For example, the instruction may direct navigation to a “wall picture” instead of a “painting,” a “place with cold drinks” instead of a “refrigerator”), a “patio door” instead of a “door,” or a “brown leather chair” instead of a “sofa.” The use of a multi-modal model described herein enables use of open vocabulary for navigation by generating a query embedding without the need to identify a specific semantic object.

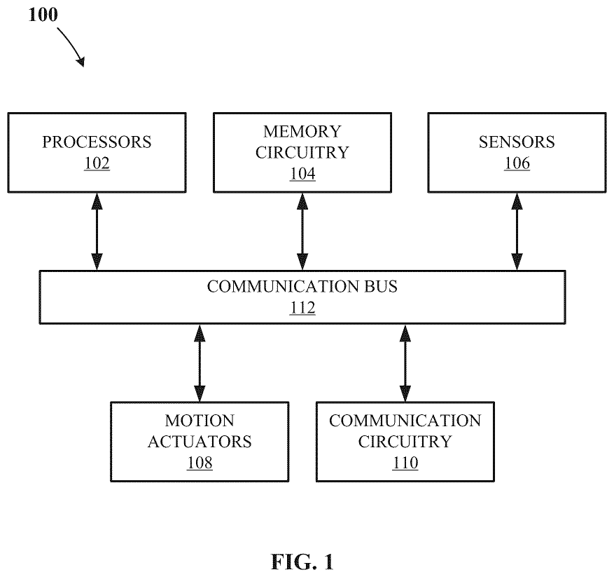

FIG. 1 is a block diagram of a mobile device 100 implementing language-based navigation according to one or more embodiments of the disclosure. Mobile device 100 includes one or more processors 102, memory circuitry 104, one or more sensors 106, and one or more motion actuators 108. The memory circuitry 104 is configurable to store computer-readable instructions configured to be executed by the one or more processors 102 to perform the techniques, processes, and/or methods described herein in support of language-based navigation. Additionally, memory circuitry 104 stores a multi-modal model and a pose-embedding node graph described herein.

The one or more sensors 106 include imaging and/or ranging sensors (e.g., one or more cameras, one or more light detection and ranging (LIDAR) sensors, etc.) to capture information about the environment. For example, as described herein, images from one or more cameras are used for mapping and navigation. Additionally, the one or more sensors 106 optionally include one or more audio sensors (e.g., microphone, array of microphones, or other audio sensors) to capture audio commands for navigation (e.g., natural language navigation requests). The one or more sensors 106 can include other sensors to support navigation including odometry sensors to estimate changes in position of mobile device 100 during mapping or navigation operations, one or more location sensors (e.g., global navigation satellite system (GNSS), global positioning system (GPS), etc.), or one or more motion and/or orientation sensors (e.g., accelerometers, gyroscopes, inertial measurement units (IMUs), etc.).

Motion actuators 108 enable movement of mobile device 100 for mapping the environment and/or for navigation within the environment based on language-based inputs. For example, the motion actuators 108 optionally include prime movers, motor controllers and systems, steering systems, and/or braking systems, etc. to control movement of wheels of mobile device 100.

Optionally, mobile device 100 includes communication circuitry 110, which is optionally used to receive language-based navigation instructions from another electronic device (e.g., a desktop or laptop computer, a tablet computer, a mobile phone, etc.) in communication with mobile device 100. One or more communication buses 112 are optionally used for communication between the above-mentioned components of mobile device 100.

Mobile device 100 is not limited to the components and configuration of the block diagram shown in FIG. 1, but can include fewer, other, or additional components in multiple configurations.

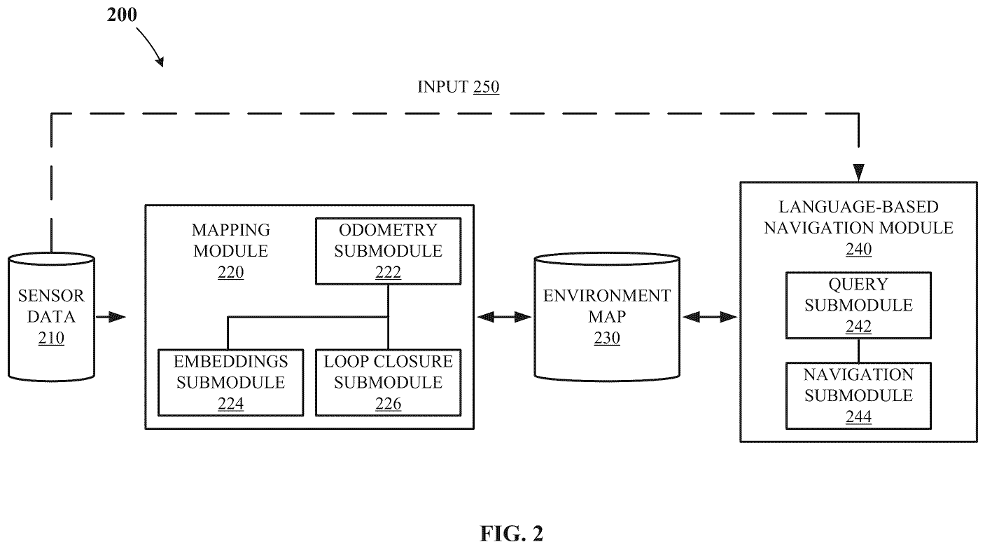

FIG. 2 is a block diagram of a system for language-based navigation in a mapped environment using a pose-embedding node graph according to one or more embodiments of the disclosure. System 200 is optionally implemented on mobile device 100 (e.g., a robot). As shown in FIG. 2, system 200 includes a mapping module (e.g., mapping module 220) for mapping operations and a language-based navigation module (e.g., language-based navigation module 240) for navigation operations. Mapping module 220 (e.g., including odometry submodule 222, embeddings submodule 224, and/or loop closure submodule) and/or language-based navigation module 240 (e.g., including query submodule 242 and/or navigation submodule 244) are optionally implemented as one or more software modules and/or code that can be executed by one or more processors (e.g., one or more processors 102) to perform the mapping and language-based navigation described herein. In some embodiments, the modules and/or submodules of system 200 are implemented using software, hardware, or firmware, or a combination thereof.

The mapping operations of mapping module 220 and/or the navigation operations of language-based navigation module 240 are based on sensor data 210 and/or an environment map 230. Sensor data 210 includes data from the one or more sensors (e.g., sensors 106). For example, sensor data 210 includes measurements corresponding to odometry, motion, attitude, orientation, and/or pose of mobile device 100. Additionally, sensor data 210 includes image and ranging information. For example, image and ranging information include LIDAR sensor measurements (e.g., point clouds), images (e.g., monoscope or stereoscopic), or depth information. In some embodiments, sensor data 210 includes audio data such as natural language voice commands. In some embodiments, environment map 230 includes a multi-modal node graph such as a pose-embedding node graph as described in further detail herein.

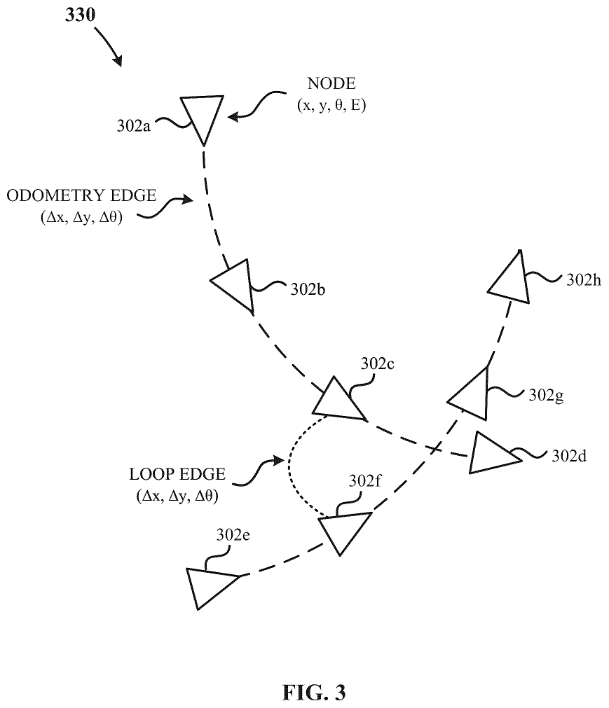

In some embodiments, mobile device 100 is configured to implement mapping module 220 to map an environment in which mobile device 100 operates. The mapping module 220 obtains sensor data 210 (e.g., including data from sensors 106 and/or from memory circuitry 104) to generate a map of the environment, illustrated as environment map 230. Environment map 230 is stored in and/or obtained from memory (e.g., memory circuitry 104). As described herein, in some embodiments, environment map 230 includes a multi-modal node graph such as a pose-embedding node graph (also referred to as a “pose-embedding graph”), which includes visual embeddings, such as described in further detail herein with reference to FIG. 3.

In some embodiments, environment map 230 is optionally created by another mobile device (e.g., a device similar to or identical to mobile device 100) that is operating or previously operated in the environment). For example, environment map 230 can be received from the other mobile device and stored by mobile device 100 (e.g., using memory circuitry 104) or otherwise obtained by mobile device 100 (e.g., using communication circuitry 110) from a computing system such as a computer server, a database server, and/or the like) when or as needed for mapping and navigation of the environment.

In some embodiments, the processing functionality of mapping module 220 is optionally implemented on another device in communication with mobile device 100. For example, mobile device 100 captures sensor data 210 (e.g., one or more images, odometry information, etc.), which is transmitted to another computing system (e.g., a server, a desktop or laptop computer, etc.) implementing mapping module 220 to generate an environment map 230. The environment map 230 is then transmitted to, or otherwise obtained by, mobile device 100 for use in language-based navigation.

The operation of mapping module 220 optionally includes generating environment map 230, including generating an initial environment map of an otherwise unmapped environment in which mobile device 100 operates. Additionally, the operation of mapping module 220 optionally includes updating environment map 230, including iterating and/or developing the initial environment map via navigation and re-mapping of the environment to generate an updated environment map of the environment in which mobile device 100 operates. For example, mobile device 100 optionally updates the map based on images captured during navigation within the environment (e.g., autonomously or in response to input including language-based navigation commands, etc.). For example, mobile device 100 can be configured to generate and/or update environment map 230 in response to receiving an input including a description associated with an object in a mapped environment, an environment to be mapped, and/or the like.

Generating (and/or updating) environment map 230 optionally relies on odometry submodule 222, embeddings submodule 224, and/or loop closure submodule 226. In some embodiments, mapping module 220 implements simultaneous localization and mapping (SLAM) techniques to generate and/or update environment map 230. In some embodiments, odometry submodule 222 is configured to track and/or localize mobile device 100 within the environment over time as mobile device 100 navigates within the environment. For example, images captured by one or more image sensors (e.g., cameras, LIDAR sensors, etc.) are associated with a pose of mobile device 100 at the time of capture. In some embodiments, odometry submodule 222 is used to determine the pose of mobile device 100 to enable associating the pose with one or more images captured by the one or more image sensors. In some embodiments, the pose includes a location and/or orientation of the mobile device. For example, a location of a pose of mobile device 100 in the environment during navigations is optionally determined relative to a reference frame defined in terms of a dual-coordinate system for defining position in the environment (e.g., x and y coordinates of a coordinate system defined in connection with positions and/or orientations of mobile device 100 in the environment), and orientation of the pose is optionally a heading or angle (e.g., a yaw of mobile device 100 in the environment). It is understood that pose is not limited to these example representations of location and/or orientation, and other suitable coordinate system may be used (e.g., spherical coordinate system, cylindrical coordinate system, etc.).

In some embodiments, embeddings submodule 224 is configured to generate embeddings based on input from sensor data 210. For example, in some embodiments, the input includes data corresponding to images captured by one or more image sensors. In particular, embeddings submodule 224 is configured to generate an embedding corresponding to a representation of the visual information in an image in connection with a pose of mobile device 100 in the environment. The embedding is generated in connection with a multi-modal node graph including a plurality of embeddings corresponding to representations of visual information in images of the mapped environment.

As described in more detail herein, the embedding is optionally generated using a multi-modal model that generates embeddings in a shared dimensional space for both language based and visual based inputs. In some embodiments, the dimensionality of the embeddings space is tuned based on memory and/or processing requirements, such as described in further detail with reference to FIG. 3. In some embodiments, the dimensionality of the embeddings space is 128 or less. In some embodiments, the dimensionality of the embeddings space is different (e.g., 256, 512, etc.). As described herein, environment map 230 is optionally implemented as a pose-embedding node graph, with each node representing a pose and corresponding embedding, as described in further detail with reference to FIG. 3.

Additionally or alternatively, loop closure submodule 226 is optionally configured to reduce the size of environment map 230 and/or to reduce errors in environment map 230 due to odometry drift error. Loop closure is optionally implemented using the embeddings generated by embeddings submodule 224 to improve the loop closure process (e.g., instead of or in addition to using raw images). Using embeddings instead of images for loop closure can reduce memory and/or processing requirements for loop closure, and optionally enable faster and more accurate loop closure and mapping.

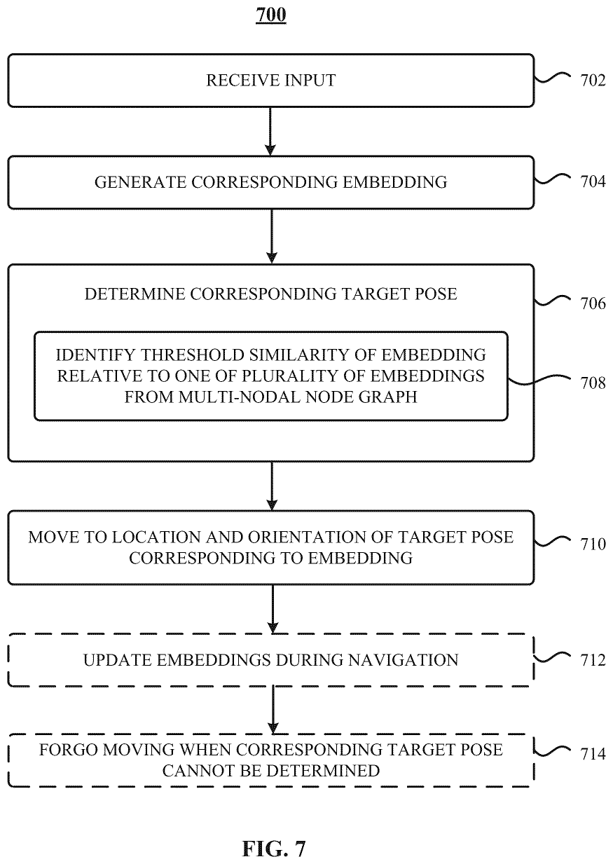

Language-based navigation module 240 is configured to cause navigation of mobile device 100 in response to input including a language-based command. For example, language-based commands include a language command recorded using audio sensors (e.g., corresponding to one or more sensors 106) and/or a text input (e.g., using a touch screen of mobile device 100). In some embodiments, the language command is recorded or entered as text on another electronic device and transmitted to mobile device 100. The language-based navigation module 240 accepts a language command 250 and determines a target pose of the mobile device 100 in the mapped environment corresponding to the language command. When a target pose is determined corresponding to the language command, the language-based navigation module 240 causes navigation of the mobile device to a location and an orientation of the target pose in the mapped environment. As described in more detail herein, a query submodule 242 is optionally used to generate an embedding corresponding to the language command, which is used to query the environment map 230, as described with reference to FIGS. 7-8. A target pose from the environment map corresponding to the query can be provided as a navigation destination for navigation submodule 244, which can execute navigation to the target pose (e.g., without the need for semantic understanding to determine a navigation goal and/or without a need for determining a preferred pose relative to the goal of navigation). The navigation submodule 244 optionally corresponds to or uses the one or more motion actuators 108. For example, navigation submodule 244 optionally implements a global planner, local planner, and/or controller to navigate to the target pose. In some embodiments, navigation submodule 244 is configured to determine a trajectory and/or one or more waypoints in real-time by which to navigate to the location and orientation of the target pose.

In some embodiments, environment map 230 is implemented using a specialized vector storage solution (e.g., Milvus, Pinecone, FAISS, etc.) to effectively manage the storage of visual embeddings (e.g., from embeddings submodule 224) and facilitate efficient query operations (e.g., by query submodule 242). A specialized vector storage solution improves or optimizes memory utilization and expedites the process of querying the graph for the closest neighboring embeddings, which are important for accurate and real-time navigation.

FIG. 3 illustrates a pose-embedding node graph according to one or more embodiments of the disclosure. The pose-embedding node graph is also referred to herein as a multi-modal node graph because the pose-embedding node graph includes both pose and embedding information, with the embedding information for both visual and language inputs in the same embedding space. In some embodiments, generating the plurality of nodes of the multi-modal graph includes generating, using an image encoder of the multi-modal model, embeddings from captured images at various poses during movement of mobile device 100 in the environment.

As shown in FIG. 3, pose-embedding node graph 330 includes a plurality of nodes, such as nodes 302a-302h. As shown in FIG. 3, pose is represented at each node using at least three values representing location and orientation of the mobile device in the mapped environment. For example, in some embodiments, pose at a node is represented using two positional coordinates (e.g., x and y coordinates of mobile device 100 in the environment), and one orientation coordinate (e.g., an angle such as yaw of mobile device 100 in the environment). Thus, as shown in FIG. 3, pose is represented using three values (x, y, θ) for location and orientation at each node. It is understood that the illustrated pose-embedding node graph of eight nodes is for illustration purposes, but the pose-embedding node graph may include a different number of nodes (e.g., subject to the size of the environment, memory constraints, etc.). It is understood that the location in pose-embedding node graph 330 is represented in two-dimensions, but the pose-embedding node graph may include other representations of location, such as a three-dimensional representation of location (x, y, z) and/or orientation (e.g., rotational quaternions), or in other coordinate systems.

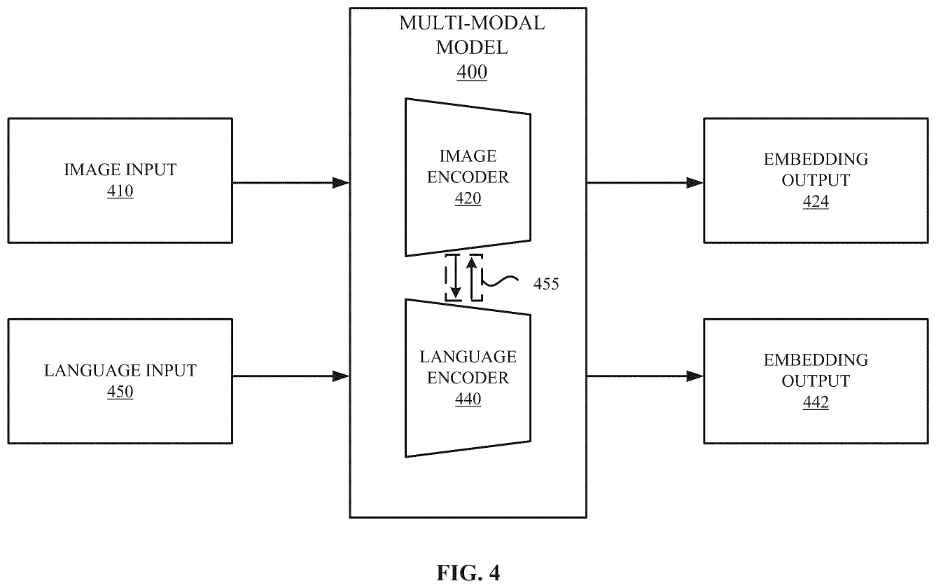

In addition to specifying a pose, the nodes of pose-embedding node graph 330 include an embedding (labeled “E”) representing the visual content from one or more images corresponding to the node pose. The generation of embeddings is described in more detail with reference to FIG. 4.

Pose-embedding node graph 330 illustrates edges between pairs of nodes, also referred to as odometry edges and shown as dashed lines in FIG. 3, representing a relative pose offset (and optionally an uncertainty in the odometry data). For example, when pose is represented using (x, y, θ), an odometry edge is optionally represented using the offset (Δx, Δy, Δθ). Thus, the odometry edges within pose-embedding node graph 330 represent spatial relationships between poses at different nodes (e.g., capturing the positional shifts that occur between nodes). Additionally, pose-embedding node graph 330 illustrates some edges, referred to as loop edges, representing a relative pose offset for two nodes when a loop closure is detected. As described herein, a loop closure is optionally detected based on similarity of the node pose and/or similarity in the embeddings at two the two nodes.

As described herein, the computationally efficient language-based navigation using a pose-embedding node graph mapping of an environment relies on a multi-modal model that generates embeddings in a shared embedding space for language or visual inputs. FIG. 4 illustrates a multi-modal model 400 according to one or more embodiments of the disclosure. As shown, multi-modal model 400 includes an image encoder 420 configured to generate output embeddings 424 from input images 410, and includes a language encoder 440 (also referred to as a text encoder) configured to generate output embeddings 442 from language inputs 450. The image encoder 420 and language encoder 440 of multi-modal model 400 are jointly trained (indicated by arrows 455 between the encoders) using image and language (e.g., text) pairs. Thereby, the image encoder 420 and language encoder 440 of multi-modal model 400 are configured to generate embeddings of a shared dimensionality in a shared embedding space for one or more language inputs (e.g., including text or audio converted to text, including natural language inputs) or one or more visual inputs (e.g., images). In some embodiments, multi-modal model 400 is (or includes) a contrastive language image pre-training (CLIP) model. It is understood that a CLIP model is one example multi-modal model, and that other suitable multi-modal models can be used to generate the embeddings of a shared dimensionality in the shared embedding space for language and visual inputs.

As a byproduct of joint training, similar embeddings are able to be generated in shared embedding space. For example, the multi-modal model generates a first respective embedding of a plurality of embeddings output by the multi-modal model for a respective input of the one or more inputs including an image of a respective object (e.g., an image of a cat with attire including a red beret, red scarf, and black-and-white striped shirt). The multi-modal model also generates a second respective embedding of the plurality of embeddings output by the multi-modal model for a respective input of the one or more inputs including a text description of the respective object (e.g., “a French cat”). The first and second embeddings are generated in the shared dimensionality space, and based on the joint training should result in above a threshold similarity between the first and second embeddings (e.g., using a cosine similarity between the embeddings) despite being output by different encoders and different types of inputs.

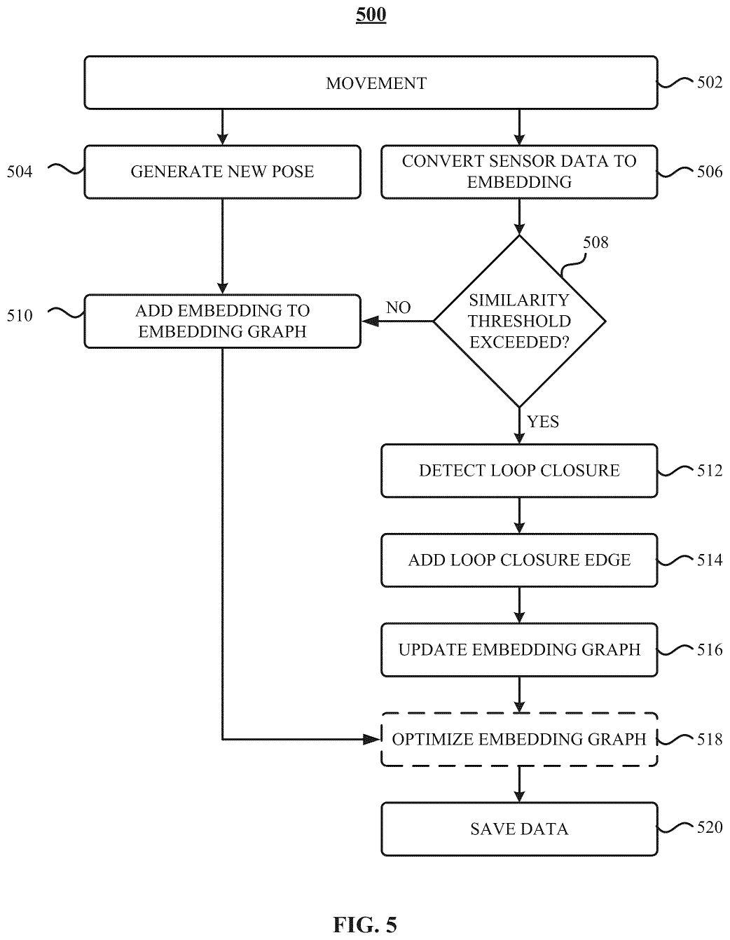

As described above, a multi-modal model (e.g., multi-modal model 400) is used for generating an environment map (e.g., environment map 230) including embeddings, such as a pose-embedding node graph (e.g., pose-embedding node graph 330). The pose-embedding node graph and mapping method described herein improves environmental map stability and is more computationally efficient by representing environmental information with embeddings instead of as a semantic environmental map. FIG. 5 is a flow diagram of an example method 500 for mapping an environment according to one or more embodiments of the disclosure. Method 500 is optionally implemented by mobile device 100 (or another electronic device) operating in an environment based on inputs from one or more sensors (e.g., sensors 106). For example, mapping is optionally performed using mapping module 220 and/or using one or more processors (e.g., processors 102) executing instructions stored in memory (e.g., memory circuitry 104), operating on inputs from one or more image and/or ranging sensors (e.g., two-dimensional images captured by a camera sensor) and/or position and/or orientation sensors (e.g., odometry sensors, motion sensors, location sensors, etc.). The mapping operation is optionally based on SLAM techniques augmented with embeddings from a multi-modal model.

At block 502, mobile device 100 moves within an environment and obtains sensor data (e.g., sensor data 210, etc.) from one or more sensors (e.g., one or more sensors 106). In some embodiments, while moving within the environment, mobile device 100 uses the one or more sensors to capture images in connection with changes in location and/or orientation of mobile device 100 within the environment. For example, movement of mobile device 100 includes changing location without changing orientation, changing orientation without changing location, or changing location and orientation. Location and orientation can be tracked, for example, using oriented features from accelerated segment test (FAST) and rotated binary robust independent elementary features (BRIEF) SLAM (ORB-SLAM) and/or LIDAR iterative closest point (ICP) techniques, among other possibilities. ORB-SLAM and/or LIDAR-ICP are visual odometry techniques that enable accurate tracking of distinct visual features across frames for real-time localization updates. Additionally, the inclusion of LIDAR-ICP improves precision by iteratively aligning point cloud data across frames to mitigate noise and inconsistencies, thereby enhancing the reliability of position and orientation estimates. Note that for ease of illustration and description, method 500 does not describe an initial node captured at an initial position (e.g., by definition a new node with a new pose and a new embedding).

In some embodiments, odometry submodule 222 can be configured to determine a new pose of mobile device 100 in the environment that is sufficiently different from prior poses of mobile device 100. The degree of difference required to identify a new pose may vary as a function of the memory and processing constraints of the system (e.g., striking a balance between data richness and resource efficiency, preserving crucial trajectory points while minimizing redundancy, etc.). In some embodiments, to streamline memory consumption, mobile device 100 generates a new node and saves a new embedding for a new pose when the location coordinate is a threshold distance from a prior pose of mobile device 100 (e.g., 10 cm, 30 cm, 50 cm, 100 cm, etc.) and/or the orientation coordinate is a threshold angular displacement from a prior pose of mobile device 100 (e.g., 15 degrees, 30 degrees, 45 degrees, 60 degrees, etc.). In some embodiments, mobile device 100 generates nodes and saves embeddings for poses more often (e.g., reducing the threshold distance or angle to create a new node/pose), but uses optimization of the pose-embedding node graph to eliminate redundant nodes. For ease of description, method 500 assumes that device movement at block 502 is sufficient to generate a new node corresponding to a new pose.

At block 504, optionally in parallel with operation at other blocks (e.g., capture of image at block 502 or generating a new embedding form the image captured at block 506, etc.), mobile device 100 generates a new node when the odometry information (e.g., using odometry submodule 222) indicates a new pose corresponding to a new location and orientation of mobile device 100 in the environment.

At block 506, mobile device 100 converts a captured image at block 502 to a corresponding embedding using a multi-modal model. For example, image encoder 420 of multi-modal model 400 converts the input image to an embedding output as described with reference to FIG. 4.

At block 508, mobile device 100 determines whether a measure of similarity of the new embedding to one or more prior embeddings in the pose-embedding node graph (e.g., environment map 230, pose-embedding node graph 330) is greater than or equal to a threshold similarity. In some embodiments, the similarity measure can include, for example, a cosine similarity metric, optionally representing similarity between −1 and 1, where −1 indicates opposite embeddings, 1 indicates proportional embeddings, and 0 indicates orthogonal embeddings. It is understood that other suitable similarity comparison techniques for embeddings can be used. In some embodiments, the embedding similarity is determined for the new embedding and each of a subset of the plurality of embeddings in the pose-embedding node graph. For example, the embeddings corresponding to nodes within a threshold distance (e.g., location coordinates) and/or embeddings corresponding to nodes within a threshold orientation (e.g., orientation coordinate). In some embodiments, a similarity of the new embedding to each of the plurality of embeddings in the pose-embedding node graph (or a subset thereof) is determined and a maximum similarity is determined for use in comparison to the similarity threshold at block 508. In some embodiments, in response to determining that a measure of similarity (e.g., cosine similarity, etc.) of an embedding to one or more prior embeddings in the pose-embedding node graph (e.g., as determined at block 508) is less than the threshold similarity (e.g., 0.85, 0.9, 0.95, 0.99, etc. for a cosine similarity between −1 and 1), at block 510, mobile device 100 adds the new embedding as a new embedding corresponding to the new pose at the new node in the pose-embedding node graph (e.g., generated at block 504). The threshold similarity for poses is optionally predetermined and implementers can set the threshold to optimize performance of the mapping module.

When the embedding similarity is greater than or equal to a threshold similarity, mobile device 100 detects a loop closure in the multi-modal node graph at block 512 (e.g., e.g., using loop closure submodule 226). For example, in response to identifying the threshold similarity of the embedding to one of a plurality of embeddings of a multi-modal node graph is greater than or equal to the threshold similarity (e.g., 0.85, 0.9, 0.95, 0.99, etc. for a cosine similarity between −1 and 1), a loop closure is detected. The threshold similarity for embeddings is optionally predetermined and implementers can set the threshold to optimize performance of the mapping module.

At block 514, mobile device 100 adds a loop closure edge to the pose-embedding node graph between the new node (e.g., generated at block 504) and the node with an embedding with greater than the threshold similarity. For example, mobile device 100 can add the loop closure edge illustrated in FIG. 2 between two nodes (e.g., using loop closure submodule 226).

At block 516, mobile device 100 updates the multi-modal node graph (one or more nodes and/or one or more embeddings in the multi-modal node graph) in accordance with the new embedding and the added loop closure edge. In some embodiments, updating the multi-modal node graph includes updating the pose-embedding node graph, as described herein. For example, loop closure correction techniques are applied to systematically rectify pose estimates and recalibrating perception of mobile device 100 of the environment reflected in the environment map.

At block 518, mobile device 100 optionally optimizes the pose-embedding node graph (e.g., pose-embedding node graph 330). In some embodiments, optimizing the pose-embedding node graph includes updating the poses in the pose-embedding graph in accordance loop closure correction techniques. In some embodiments, optimizing the embedding graph can include, for example, removing nodes that are redundant (e.g., embedding and/or poses are within a threshold).

At block 520, the mobile device saves updates to the pose-embedding node graph from adding a new node with a new embedding and new pose, updating one or more nodes in accordance with detecting a loop closure, and/or one or more optimization processes.

As described herein, the pose-embedding node graph is optionally also updated during navigation by mobile device 100. For example, after mapping the environment, mobile device 100 moves in response to a language-based command. Additionally or alternatively, mobile device 100 autonomously navigates to ensure an updated environmental map (or based on other navigation command different than a language-based command). During navigation, mobile device 100 may detect a change in the environment. For example, one or more new obstacles may appear in the environment or at a different location within the environment due to movement of objects (e.g., people, furniture, doors, pets, appliances, etc.). The mapping operations by mapping module 220 enables updating of embeddings to reflect the changes in the environment.

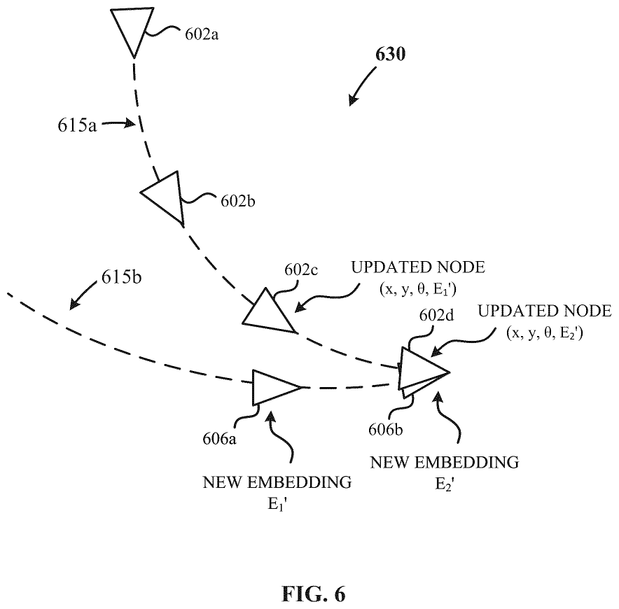

FIG. 6 illustrates a updating a pose-embedding node graph according to one or more embodiments of the disclosure. FIG. 6 indicates two trajectories in the node graph representation including a first trajectory 615 with nodes 602a-602d corresponding to first environment mapping operation and a second trajectory 604 with nodes 606a-606b. Similar to the discussion with respect to FIG. 3, each of nodes 602a-602d in the first trajectory is represented with a pose and an embedding. When a new pose is detected within a threshold similarity of a prior pose, but the corresponding embedding has changed (e.g., less than a threshold similarity to the previously stored corresponding embedding), the node can be updated. For example, FIG. 6 illustrates node 606a and node 602c with a pose within a threshold distance (e.g., the location offset is less than a threshold and the orientation offset is less than a threshold). Accordingly, the embedding at node 602c is updated with the new embedding at node 606a, as reflected in the storing of embedding E′ at node 602c. In some embodiments, node 606a is removed as redundant (e.g., as part of optimization similar to block 518). In some embodiments, the updating of node 602c with embedding E′ is performed using the similarity of the new pose corresponding to node 606a and the difference in the new embedding generated for the new pose, without actually creating node 606a. When the new pose of node 606a is similar to the existing pose of 602c, but the embeddings are similar (e.g., greater than a threshold similarity), node 602c is not updated with new embedding E′ (e.g., node 602c remained associated with existing embedding E). In a similar manner, node 602d with an above threshold similarity in pose and a below threshold similarity in embedding is updated to reflect embedding E′ corresponding to the image captured at node 606b. When poses are not similar (e.g., less than the threshold similarity for poses), new nodes are optionally as described in method 500 with the new embeddings.

It is understood that the threshold similarity described herein may be the same threshold or a different threshold depending on the context and/or the implementation. For example, in some embodiments, the same threshold similarity is used for comparing embeddings for updating a node during navigation in an environment (as described with reference to FIG. 6) and as for loop closure (e.g., as described with reference to FIG. 5). In some embodiments, a different threshold similarity is used. For example, loop closure may require a higher threshold similarity to correct errors in the environment map compared with the updating of an embedding at a node of the graph during navigation. Additionally or alternatively, in some embodiments, threshold similarity in pose may be the same for adding a new node during mapping (e.g., as described with reference to FIG. 5) as for updating an embedding at a node (e.g., as described with reference to FIG. 6). In some embodiments, the threshold similarity in pose may be different for adding a node versus updating a node. In some embodiments, the threshold similarity for poses and for embeddings may be the same, or alternatively, may be different.

FIG. 7 illustrates a flow diagram of an example method for language-based navigation according to one or more embodiments of the disclosure. As shown, method 700 can be implemented, performed, or otherwise executed, for example, at a mobile device (e.g., mobile device 100) in communication with one or more input devices (e.g., one or more sensors 106).

At block 702, method 700 includes receiving an input including a description associated with an object in a mapped environment. The input is optionally received using one or more input devices (e.g., one or more sensors 106). In some embodiments, the input includes a voice commands, such as a natural language navigation request. In some embodiments, the mapped environment includes a physical space or environment (e.g., a user's home, a building, an office space, a stadium, etc.) that the mobile device is designed to operate in.

At block 704, method 700 includes generating an embedding corresponding to the input (e.g., using query submodule 242). For example, the embedding is generated using a language encoder of a multi-modal model (e.g., language encoder 440 of multi-modal model 400). As described herein, the same multi-modal model is used to generate embeddings in a shared embedding space for both language-based inputs (e.g., voice commands, natural language navigation requests, etc.) and visual-based inputs (e.g., images captured by the mobile device in the mapped environment). The multi-modal model optionally includes machine learning circuitry (e.g., neural networks, encoders, etc.) for converting or otherwise transforming high-dimensional data such as text and images into shared, relatively lower-dimensional representations for use in computationally efficient navigating within and mapping of an environment.

At block 706, method 700 includes determining a target pose of the mobile device in the mapped environment corresponding to the embedding. In some embodiments, the target pose of the mobile device in the mapped environment can be determined, at block 708 by identifying a threshold similarity of the embedding to one of a plurality of embeddings of a multi-modal node graph. For example, the embedding is used to a query for the environmental map (e.g., using query submodule 242). For example, identifying the threshold similarity of the embedding to one of a plurality of embeddings of a multi-modal node graph includes comparing the embedding to the embeddings in a multi-modal node graph includes representations of a plurality of poses of the mobile device in the mapped environment and the plurality of embeddings correspond to the plurality of poses of the mobile device in the mapped environment. In some embodiments, a maximum similarity between the embedding corresponding to the input and the plurality of embeddings in the multi-modal node graph is identified. When the maximum similarity is greater than a threshold, the target pose is determined as the pose of the corresponding embedding with maximum similarity. In some embodiments, determining the target pose of the mobile device in the mapped environment corresponding to the embedding includes determining the top-k clustering result by querying the embeddings in the vector store corresponding to environment map 230.

In some embodiments, in response to encoding an input, query submodule 242 can be configured to search for or otherwise determine a similar embedding (e.g., a relatively maximum similarity embedding) substantially corresponding to the associated input. For example, query submodule 242 can be configured to search for or otherwise locate the closest visual embedding in the multi-modal node graph (e.g., the pose-embedding graph) with respect to the embedding corresponding to the encoded input. In some embodiments, in response to locating a closest matching embedding within the multi-modal node graph, the location associated with the identified and corresponding pose is designated as a navigation goal. In some embodiments, the closest matching embedding includes a target pose in the mapped environment.

At block 710, method 700 includes moving the mobile device to the location and orientation of the target pose in the mapped environment.

In some embodiments, while mobile device 100 is moving to the location and the orientation of the target pose in the mapped environment, the mobile device continues to capture images and, at block 712, the mobile device optionally updates the environment map (e.g., as described with respect to FIG. 6).

In some embodiments, when a target pose is not determined (e.g., when the similarity between the embedding corresponding to the input and the plurality of embeddings in the multi-modal node graph is less than the threshold similarity), at block 714, method 700 includes forgoing moving of the mobile device in the environment in response to the input.

Referring back to FIG. 1, the one or more processors 102 include any suitable processing device configured to run and/or execute a set of instructions or code. For example, the one or more processors 102 optionally include one or more general processors, one or more graphics processing units (GPUs) and/or one or more digital signal processors (DSPs) for performing language-based navigation and/or mapping according to one or more embodiments of the disclosure. The one or more processors 102 optionally include a hardware-based integrated circuit (IC), a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC), and/or the like.

Memory circuitry 104 is or includes any suitable data storage device, such as a random access memory (RAM), a memory buffer, a hard drive, a read-only memory (ROM), an erasable programmable read-only memory (EPROM), an electrically erasable programmable read-only memory (EEPROM), a portable memory (e.g., a flash drive, a portable hard disk, etc.), and/or the like. For example, memory circuitry 104 is or includes a non-transitory computer-readable storage medium (e.g., flash memory, RAM, or other volatile or non-volatile memory or storage) that stores computer-readable instructions configured to be executed by one or more processors 102 to perform the techniques, processes, and/or methods described herein (e.g., in the context of FIGS. 2-7). In some embodiments, memory circuitry 104 includes more than one non-transitory computer-readable storage medium. In some embodiments, memory circuitry 104 is configurable to store one or more environment maps, such as a pose-embedding node graph (e.g., environment map 230). Additionally or alternatively, memory circuitry 104 is configurable to store programs or instructions to create or update one or more environment maps (e.g., corresponding to mapping module 220) and/or to navigate within an environment using language commands (e.g., language-based navigation module 240). A non-transitory computer-readable storage medium can be any medium (e.g., excluding a signal) that can tangibly contain or store computer-executable instructions for use by or in connection with the instruction execution system, apparatus, or device. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

Mobile device 100 optionally includes one or more image sensors and/or ranging sensors. The image sensors optionally include one or more visible light image sensors, such as charged coupled device (CCD) sensors, and/or complementary metal-oxide-semiconductor (CMOS) sensors operable to obtain images of the environment. The image sensors also optionally include one or more infrared (IR) sensors, such as a passive or an active IR sensor (optionally including an IR emitter), for detecting infrared light from environment. The image sensors also optionally include one or more depth sensors configured to detect the distance of physical objects from mobile device 100. In some embodiments, information from one or more depth sensors allows the device to identify objects in the environment to enable mapping of the environment (e.g., identify boundaries of and obstacles within the environment).

Communication circuitry 110 optionally includes hardware to implement communications using suitable communications protocols. For example, communication circuitry 110 optionally includes circuitry for communicating with other electronic devices, such as using the Internet, intranets, a wired network and/or a wireless network, cellular networks, and wireless local area networks (LANs). Communication circuitry 110 optionally includes circuitry for communicating using near-field communication (NFC) and/or short-range communication, such as Bluetooth®.

Referring back to FIG. 2, system 200 includes a mapping module 220 and language-based navigation module 240. The mapping module 220 is shown including an odometry submodule 222, an embeddings submodule 224, and a loop closure submodule 226. The language-based navigation module is shown including a query submodule 242 and a navigation submodule 244. In some embodiments, the one or more modules or submodules are implemented as programs or instructions (e.g., software or firmware) stored in memory (e.g., memory circuitry 104), which is executed by one or more processors (e.g., one or more processors 102). In some embodiments, the one or more modules or submodules are implemented as hardware (e.g., an ASIC, an FPGA, a CPLD, discrete logic, and/or the like. In some embodiments, one or more of the modules or submodules are implemented using one or more neural networks (e.g., models implemented in software or firmware and executed by one or more processors or hardware based neural networks). It is understood that the modules and submodules are for illustration purposes and that implementation of the submodules or modules can be different (e.g., embedding submodule and a portion of query submodule can be implemented in a combined module or submodule). For example, odometry submodule 222 is optionally hardware, software, and/or firmware implementing odometry tracking algorithms such as a rotary encoder to measure rotation of wheels of mobile device 100 and/or visual odometry algorithms based on image processing and/or feature extraction. For example, embeddings submodule 224 and/or query submodule 424 are optionally hardware, software, and/or firmware implementing a multi-modal model (e.g., a neural network configured) to convert visual inputs into embeddings for mapping and/or language-based navigation. For example, loop closure submodule 226 is optionally hardware, software, and/or firmware implementing detection of a loop closure using images and/or embeddings, updating of a pose-embedding node graph to include loop edges, and/or optimizing the pose-embedding node graph based on the additional constraints of loop edges. For example, query submodule 242 is optionally hardware, software, and/or firmware implementing a querying algorithm to determine a target pose in a pose-embedding node graph using a query embedding (e.g., identifying a maximum similarity between embeddings in the node graph and the query embedding, determining that the maximum similarity exceeds a threshold). For example, navigation submodule 244 is optionally hardware, software, and/or firmware implementing a navigation algorithm to control movement of the mobile device, such as based on a target pose (e.g., including one or more planners and to determine a navigation route and controlling one or more motion actuators to control motion and steering in the environment).

Implementors should ensure that an appropriate level of information is used to facilitate navigation and mapping of an environment, and are reminded to abide by appropriate privacy regulations and practices, to the extent that personal, controlled, or otherwise private information is used. Such practices may include informing users or any interested party of information to be collected in connection with an environment to be navigated and mapped, and obtaining, from any interested party, use permission (e.g., opt-in) for such collection and use of the information in the navigation and mapping of the environment. Such practices may additionally or alternatively include obtaining access permission in connection with accessing an environment to be navigated and mapped. Such practices may additionally or alternatively include obtaining distribution permission from any interested party in connection with distribution, storage, or later use of any information collected in connection with the environment for navigating and mapping the environment. Additionally, such practices may include obtaining use permission for information used for navigating and mapping an environment from any interested parties associated with the environment.

Therefore, according to the above, some embodiments of the disclosure are directed to a method. The method comprises, at a mobile device in communication with one or more input devices: receiving an input (e.g., a language-based navigation command), generating an embedding corresponding to the input, determining a target pose of the mobile device in the mapped environment corresponding to the embedding, and moving to a location and an orientation of the target pose in the mapped environment. Additionally or alternatively to one or more of the embodiments disclosed above, in some embodiments, determining the target pose of the mobile device in the mapped environment corresponding to the embedding includes identifying a threshold similarity of the embedding to one of a plurality of embeddings of a multi-modal node graph. The embedding is generated using a text encoder of the multi-modal model. The multi-modal node graph includes representations of a plurality of poses of the mobile device in the mapped environment and the plurality of embeddings correspond to the plurality of poses of the mobile device in the mapped environment.

Additionally or alternatively to one or more of the embodiments disclosed above, in some embodiments, the multi-modal model generates embeddings in a shared dimensionality space for one or more language inputs or one or more image inputs. Additionally or alternatively to one or more of the embodiments disclosed above, in some embodiments, a first respective embedding of the embeddings output by the multi-modal model for a first respective input including an image of a respective object and a second respective embedding of the embeddings output by the multi-modal model for a second respective input including a text description of the respective object are generated in the shared dimensionality space and have a similarity above the threshold similarity. Additionally or alternatively to one or more of the embodiments disclosed above, in some embodiments, the multi-modal model includes a contrastive language image pre-training model. Additionally or alternatively to one or more of the embodiments disclosed above, in some embodiments, a pose of the plurality of poses is represented using at least three values representing a location and an orientation of the mobile device in the mapped environment. Additionally or alternatively to one or more of the embodiments disclosed above, in some embodiments, the location is represented using at least two coordinates of a two dimensional coordinate system of the mobile device in the mapped environment and the orientation is represented by yaw of the mobile device in the mapped environment.

Additionally or alternatively to one or more of the embodiments disclosed above, in some embodiments, the method comprises, at a mobile device in communication with one or more input devices, receiving an image input, and generating an embedding corresponding to the image input. The one or more input devices include one or more image sensors. The embedding is generated using an image encoder of the multi-modal model. Additionally or alternatively to one or more of the embodiments disclosed above, in some embodiments, the mapped environment is mapped using the multi-modal model, mapping the environment includes generating a plurality of nodes of the multi-modal node graph, and generating the plurality of nodes of the multi-modal node graph includes generating, using an image encoder of the multi-modal model, a respective embedding corresponding to a respective pose corresponding to a respective image. Additionally or alternatively to one or more of the embodiments disclosed above, in some embodiments, generating the plurality of nodes of the multi-modal node graph includes receiving a first embedding output by the image encoder of the multi-modal model at a first pose, adding a new node to the multi-modal node graph with the first embedding and the first pose in accordance with a determination that the first pose has less than a threshold similarity with the plurality of poses at the plurality of nodes of the multi-modal node graph, and forgoing adding the new node to the multi-modal node graph with the first embedding and the first pose in accordance with a determination that the first embedding has a threshold similarity with a second embedding at a node of the multi-modal node graph corresponding to the first pose.

Additionally or alternatively to one or more of the embodiments disclosed above, in some embodiments, generating the plurality of nodes of the multi-modal node graph includes identifying one or more loop closures for the multi-modal node graph based on embeddings output by the image encoder of the multi-modal node graph, and updating the multi-modal node graph based on the one or more loop closures. Additionally or alternatively to one or more of the embodiments disclosed above, in some embodiments, the method further comprises, at the mobile device in communication with the one or more input devices and while moving the mobile device to the location and the orientation of the target pose in the mapped environment: receiving a first embedding output by the image encoder of the multi-modal model at a first pose, updating the respective node to include the first embedding at the first pose in accordance with a determination that the first pose has a threshold similarity with a second pose at a respective node of the plurality of nodes of the multi-modal node graph and the first embedding has less than a threshold similarity with a second embedding at the respective node, and forgoing updating the respective node in accordance with a determination that the first embedding has a threshold similarity with a second embedding at the respective node of the plurality of nodes of the multi-modal node graph corresponding to the first pose. Additionally or alternatively to one or more of the embodiments disclosed above, in some embodiments, the method further comprises, at the mobile device in communication with the one or more input devices: forgoing moving the mobile device to the location and the orientation of the target pose in the environment in accordance with identifying less than the threshold similarity of the embedding to the plurality of embeddings of the multi-modal node graph.

Additionally or alternatively to one or more of the embodiments disclosed above, in some embodiments, the one or more input devices includes one or more audio sensors and the input includes a voice command, and receiving the input includes capturing the voice command and converting the voice command into a text representation of the description associated with the object in the mapped environment. The voice command is captured via the one or more audio sensors. Additionally or alternatively to one or more of the embodiments disclosed above, in some embodiments, the one or more input devices includes an image capture device, a motion sensor, or an odometry sensor.

Some embodiments of the disclosure are directed to a mobile device. The mobile device includes one or more input devices, and one or more processors configured to perform any of the above disclosed methods. Some embodiments of the disclosure are directed to a non-transitory computer readable storage medium. The non-transitory computer readable storage medium stores one or more programs, the one or more programs comprising instructions, which when executed by one or more processors of a mobile device, cause the mobile device to perform any of the above disclosed methods. Some embodiments of the disclosure are directed to an information processing apparatus for use in a mobile device. The information processing apparatus comprises means for performing any of the above disclosed methods.

1. A method, comprising:
at a mobile device in communication with one or more input devices:
receiving, via the one or more input devices, an input including a description associated with an object in a mapped environment;
generating, using a text encoder of a multi-modal model, an embedding corresponding to the input;
determining a target pose of the mobile device in the mapped environment corresponding to the embedding, wherein determining the target pose of the mobile device in the mapped environment corresponding to the embedding comprises:
identifying a threshold similarity of the embedding to one of a plurality of embeddings of a multi-modal node graph;
wherein the multi-modal node graph includes representations of a plurality of poses of the mobile device in the mapped environment and the plurality of embeddings correspond to the plurality of poses of the mobile device in the mapped environment; and
moving the mobile device to a location and an orientation of the target pose in the mapped environment.

2. The method of claim 1, wherein the multi-modal model generates embeddings in a shared dimensionality space for one or more language inputs or one or more image inputs.

3. The method of claim 2, wherein a first respective embedding of the embeddings output by the multi-modal model for a first respective input including an image of a respective object and a second respective embedding of the embeddings output by the multi-modal model for a second respective input including a text description of the respective object are generated in the shared dimensionality space and have a similarity above the threshold similarity.

4. The method of claim 1, wherein the multi-modal model includes a contrastive language image pre-training model.

5. The method of claim 1, wherein a pose of the plurality of poses is represented using at least three values representing a location and an orientation of the mobile device in the mapped environment.

6. The method of claim 5, wherein the location is represented using at least two coordinates of a two dimensional coordinate system of the mobile device in the mapped environment and the orientation is represented by yaw of the mobile device in the mapped environment.

7. The method of claim 1, wherein the one or more input devices include one or more image sensors, the method further comprising:
receiving, via the one or more image sensors, an image input; and
generating, using an image encoder of the multi-modal model, an embedding corresponding to the image input.

8. The method of claim 1, wherein:
the mapped environment is mapped using the multi-modal model;
mapping the environment includes generating a plurality of nodes of the multi-modal node graph; and
generating the plurality of nodes of the multi-modal node graph includes generating, using an image encoder of the multi-modal model, a respective embedding corresponding to a respective pose corresponding to a respective image.

9. The method of claim 8, wherein generating the plurality of nodes of the multi-modal node graph includes:
receiving a first embedding output by the image encoder of the multi-modal model at a first pose;
in accordance with a determination that the first pose has less than a threshold similarity with the plurality of poses at the plurality of nodes of the multi-modal node graph, adding a new node to the multi-modal node graph with the first embedding and the first pose; and
in accordance with a determination that the first embedding has a threshold similarity with a second embedding at a node of the multi-modal node graph corresponding to the first pose, forgoing adding the new node to the multi-modal node graph with the first embedding and the first pose.

10. The method of claim 8, wherein the generating the plurality of nodes of the multi-modal node graph includes:
identifying one or more loop closures for the multi-modal node graph based on embeddings output by the image encoder of the multi-modal node graph, and
updating the multi-modal node graph based on the one or more loop closures.

11. The method of claim 8, further comprising:
while moving the mobile device to the location and the orientation of the target pose in the mapped environment:
receiving a first embedding output by the image encoder of the multi-modal model at a first pose;
in accordance with a determination that the first pose has a threshold similarity with a second pose at a respective node of the plurality of nodes of the multi-modal node graph and the first embedding has less than a threshold similarity with a second embedding at the respective node, updating the respective node to include the first embedding at the first pose; and
in accordance with a determination that the first embedding has a threshold similarity with a second embedding at the respective node of the plurality of nodes of the multi-modal node graph corresponding to the first pose, forgoing updating the respective node.

12. The method of claim 1, further comprising:
in accordance with identifying less than the threshold similarity of the embedding to the plurality of embeddings of the multi-modal node graph, forgoing moving the mobile device to the location and the orientation of the target pose in the environment.

13. The method of claim 1, wherein the one or more input devices include one or more audio sensors, the input includes a voice command, and receiving the input includes:
capturing, via the one or more audio sensors, the voice command; and
converting the voice command into a text representation of the description associated with the object in the mapped environment.

14. The method of claim 8, wherein the one or more input devices includes an image capture device, a motion sensor, or an odometry sensor.

15. A non-transitory computer readable storage medium storing one or more programs, the one or more programs comprising instructions, which, when executed by one or more processors of a mobile device in communication with one or more input devices, causes the mobile device to:
receive, via the one or more input devices, an input including a description associated with an object in a mapped environment;
generate, using a text encoder of a multi-modal model, an embedding corresponding to the input;
determine a target pose of the mobile device in the mapped environment corresponding to the embedding, wherein determining the target pose of the mobile device in the mapped environment corresponding to the embedding comprises:
identify a threshold similarity of the embedding to one of a plurality of embeddings of a multi-modal node graph;
wherein the multi-modal node graph includes representations of a plurality of poses of the mobile device in the mapped environment and the plurality of embeddings correspond to the plurality of poses of the mobile device in the mapped environment; and
move the mobile device to a location and an orientation of the target pose in the mapped environment.

16. A mobile device, comprising:
one or more input devices; and
one or more processors configured to:
receive, via the one or more input devices, an input including a description associated with an object in a mapped environment;
generate, using a text encoder of a multi-modal model, an embedding corresponding to the input;
determine a target pose of the mobile device in the mapped environment corresponding to the embedding, wherein determining the target pose of the mobile device in the mapped environment corresponding to the embedding comprises:
identify a threshold similarity of the embedding to one of a plurality of embeddings of a multi-modal node graph;
wherein the multi-modal node graph includes representations of a plurality of poses of the mobile device in the mapped environment and the plurality of embeddings correspond to the plurality of poses of the mobile device in the mapped environment; and
move the mobile device to a location and an orientation of the target pose in the mapped environment.

17. The mobile device of claim 16, wherein the multi-modal model generates embeddings in a shared dimensionality space for one or more language inputs or one or more image inputs.

18. The mobile device of claim 17, wherein a first respective embedding of the embeddings output by the multi-modal model for a first respective input including an image of a respective object and a second respective embedding of the embeddings output by the multi-modal model for a second respective input including a text description of the respective object are generated in the shared dimensionality space and have a similarity above the threshold similarity.

19. The mobile device of claim 16, wherein the multi-modal model includes a contrastive language image pre-training model.

20. The mobile device of claim 16, wherein a pose of the plurality of poses is represented using at least three values representing a location and an orientation of the mobile device in the mapped environment.
